(19) United States
(12) Patent Application Publication
(10) Pub. No.: US 2022/0288542 A1
(43) Pub. Date: Sep. 15, 2022

(54) MANUFACTURING APPARATUS OF ULTRA FINE BUBBLE-CONTAINED LIQUID

(71) Applicant: CANON KABUSHIKI KAISHA, Tokyo (JP)

(72) Inventors: Masahiko Kubota, Tokyo (JP); Akira Yamamoto, Kanagawa (JP); Ikuo Nakazawa, Kanagawa (JP); Hiroaki Mihara, Tokyo (JP); Hiroyuki Shimoyama, Hyogo (JP); Toshio Kashino, Kanagawa (JP)

(21) Appl. No.: 17/686,654

(22) Filed: Mar. 4, 2022

(30) Foreign Application Priority Data
Mar. 12, 2021 (JP) 2021-040221

(51) Int. Cl. B01F 23/231; B01F 23/2373; B01F 35/90

(52) U.S. Cl. CPC B01F 23/23105; B01F 23/2373; B01F 35/90; B01F 2035/99

(57) ABSTRACT

An object of the present disclosure is to provide a manufacturing apparatus of an ultra fine bubble-contained liquid that can be utilized effectively because high concentration ultra fine bubbles are maintained for a long time at the time of manufacturing of the ultra fine bubble-contained liquid. One embodiment of the present invention is a manufacturing apparatus of an ultra fine bubble-contained liquid, which includes: a container having a gas supply port through which gas is introduced and a liquid supply port through which a liquid is introduced; and a generation unit inside the container, which is configured to cause an ultra fine bubble to occur in the liquid in which the gas is dissolved.

### BACKGROUND OF THE INVENTION

### Field of the Invention

The present disclosure relates to a manufacturing apparatus of an ultra fine bubble-contained liquid.

### Description of the Related Art

In recent years, the technique has been developed that applies the characteristic of a fine bubble, such as a micro bubble whose diameter is the micrometer size and a nano bubble whose diameter is the nanometer size. In particular, the usefulness of an ultra fine bubble (in the following, also referred to as “UFB”) whose diameter is less than 1.0 μm has been verified in a variety of fields.

Japanese Patent No. 6118544 has disclosed a fine air bubble generation apparatus that generates fine bubbles by jetting a pressurized liquid in which gas is pressure-dissolved from a decompression nozzle. Further, Japanese Patent No. 4456176 has disclosed an apparatus that generates fine bubbles by repeating division and integration of a gas-mixed liquid using a mixing unit.

### SUMMARY OF THE INVENTION

Both in the apparatus described in Japanese Patent No. 6118544 and in the apparatus described in Japanese Patent No. 4456176, in addition to the UFB whose diameter is the nanometer size, the milli bubble whose diameter is the millimeter size and the micro bubble whose diameter is the micrometer size are generated in a comparatively large amount. However, the buoyant force acts on the milli bubble and the micro bubble, and therefore, there is a tendency for them to gradually float up to the liquid surface and become extinct in long-term preservation.

On the other hand, the UFB whose diameter is the nanometer size is unlikely to be affected by the buoyant force and floats in the liquid while performing Brownian motion, and therefore, is suitable to long-term preservation. However, even the UFB is affected by the extinction of the milli bubble and the micro bubble and becomes less in number as time elapses in a case where the UFB is generated together with the milli bubble and the micro bubble or the gas-liquid interface energy is small. Consequently, despite the existence of the many FUBs at the time of generation, the number is reduced at the time of the actual utilization of the UFB and it is not possible to obtain a sufficient utilization effect.

Consequently, in view of the above-described problem, an object of one embodiment of the present invention is to provide a manufacturing apparatus of an ultra fine bubble-contained liquid that can be utilized effectively because high concentration ultra fine bubbles are maintained for a long time at the time of manufacturing of the ultra fine bubble-contained liquid.

One embodiment of the present invention is a manufacturing apparatus of an ultra fine bubble-contained liquid, which includes: a container having a gas supply port through which gas is introduced and a liquid supply port through which a liquid is introduced; and a generation unit inside the container, which is configured to cause an ultra fine bubble to occur in the liquid in which the gas is dissolved.

Further features of the present invention will become apparent from the following description of exemplary embodiments with reference to the attached drawings.

### BRIEF DESCRIPTION OF THE DRAWINGS

FIG. 1 is a diagram showing an example of a UFB generation apparatus;

FIG. 2 is a schematic configuration diagram of a preprocessing unit;

FIG. 3A and FIG. 3B are a schematic configuration diagram of a dissolving unit and a diagram for explaining a dissolving state of a liquid, respectively;

FIG. 4 is a schematic configuration diagram of a T-UFB generation unit;

FIG. 5A and FIG. 5B are each a diagram for explaining details of a heating element;

FIG. 6A and FIG. 6B are each a diagram for explaining the state of film boiling in the heating element;

FIG. 7A to FIG. 7D are diagrams showing the way UFBs are generated accompanying expansion of film boiling bubbles;

FIG. 8A to FIG. 8C are diagrams showing the way UFBs are generated accompanying contraction of film boiling bubbles;

FIG. 9A to FIG. 9C are diagrams showing the way UFBs are generated by reheating of a liquid;

FIG. 10A and FIG. 10B are diagrams showing the way UFBs are generated by an impact wave at the time of disappearance of bubbles generated by film boiling;

FIG. 11A to FIG. 11C are each a diagram showing a configuration example of a post-processing unit;

FIG. 12 is a diagram showing a configuration example of a manufacturing apparatus of a UFB-contained liquid;

FIG. 13A and FIG. 13B are a diagram showing a T-UFB generation unit and a diagram showing a configuration example relating to electrical connection with an external control system;

FIG. 14 is a diagram showing a configuration example of a manufacturing apparatus of a UFB-contained liquid;

FIG. 15 is a diagram showing a configuration example of a manufacturing apparatus of a UFB-contained liquid;

FIG. 16 is a diagram showing a flow of generation of a UFB-contained liquid;

FIG. 17 is an enlarged diagram of a T-UFB generation unit;

FIG. 18A to FIG. 18C are each an enlarged diagram of a T-UFB generation unit; and

FIG. 19A to FIG. 19C are each an enlarged diagram of a T-UFB generation unit.

### DESCRIPTION OF THE EMBODIMENTS

### First Embodiment

### <<Configuration of UFB Generation Apparatus>>

In the following, an outline of a UFB generation apparatus that utilizes a film boiling phenomenon is explained.

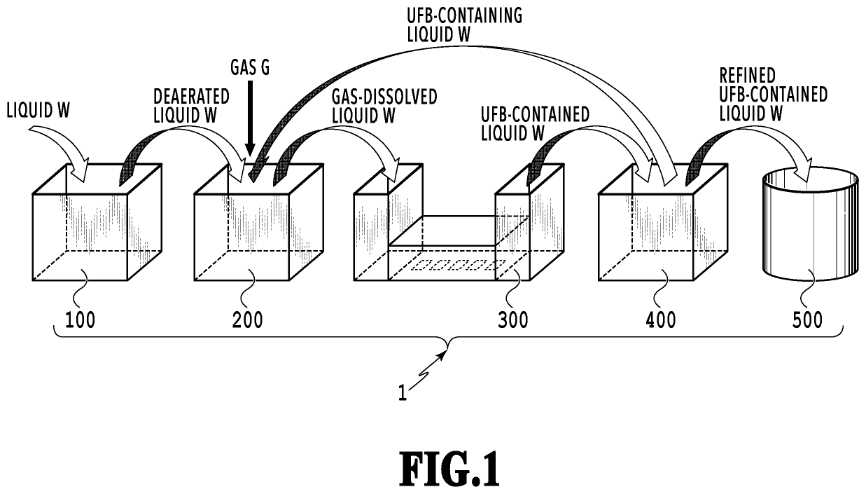

FIG. 1 is a diagram showing an example of a UFB generation apparatus that can be applied to the present embodiment. A UFB generation apparatus 1 of the present embodiment includes a preprocessing unit 100, a dissolving unit 200, a T-UFB generation unit 300, a post-processing unit 400, and a collection unit 500. For a liquid W, such as tap water, which is supplied to the preprocessing unit 100, processing unique to each unit is performed in the above-described order and the liquid W is collected by the collection unit 500 as a T-UFB-contained liquid. In the following, the function and configuration of each unit are explained. Although details will be described later, in the present specification, the UFB that is generated by utilizing film boiling accompanying rapid heat generation is referred to as T-UFB (Thermal-Ultra Fine Bubble).

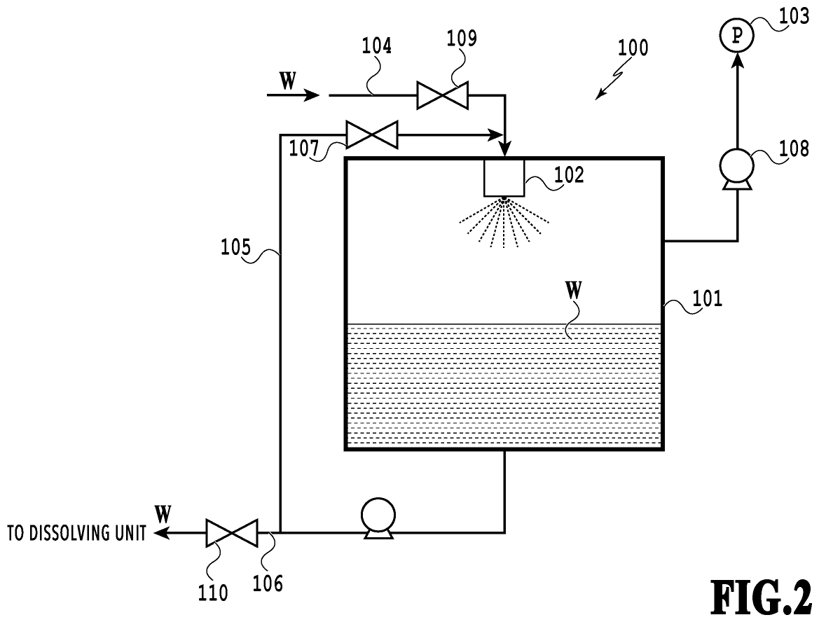

FIG. 2 is a schematic configuration diagram of the preprocessing unit 100. The preprocessing unit 100 of the present embodiment performs deaeration processing for the supplied liquid W. The preprocessing unit 100 mainly has a deaeration container 101, a shower head 102, a decompression pump 103, a liquid introduction passage 104, a liquid circulation passage 105, and a liquid discharge passage 106. For example, the liquid W, such as tap water, is supplied from the liquid introduction passage 104 to the deaeration container 101 via a valve 109. At this time, the shower head 102 provided in the deaeration container 101 turns the liquid W into fog and sprays the fog within the deaeration container 101. The shower head 102 is for facilitating vaporization of the liquid W, but as a mechanism to produce the vaporization facilitating effect, it is also possible to use a centrifugal machine or the like alternatively.

After a certain amount of the liquid W is stored in the deaeration container 101, in a case where the decompression pump 103 is activated in the state where all the valves are closed, the gas component already vaporized is discharged and at the same time, the vaporization and discharge of the gas component dissolved in the liquid W are also facilitated. At this time, it is sufficient to reduce the internal pressure of the deaeration container 101 to about several hundred to several thousand Pa (1.0 Torr to 10.0 Torr) while checking a pressure gauge 108. The gas that is deaerated by the preprocessing unit 100 includes, for example, nitrogen, oxygen, argon, carbon dioxide and the like.

It is possible to repeatedly perform the deaeration processing explained above for the same liquid W by utilizing the liquid circulation passage 105. Specifically, in the state where the valve 109 of the liquid introduction passage 104 and a valve 110 of the liquid discharge passage 106 are closed and a valve 107 of the liquid circulation passage 105 is open, the shower head 102 is activated. Due to this, the liquid W stored in the deaeration container 101 and for which the deaeration processing has been performed once is sprayed again within the deaeration container 101 via the shower head 102. Further, by activating the decompression pump 103, the vaporization processing by the shower head 102 and the deaeration processing by the decompression pump 103 are performed repeatedly for the same liquid W. Then, each time the above-described repetition processing utilizing the liquid circulation passage 105 is performed, it is possible to reduce the gas component included in the liquid W stepwise. In a case where the liquid W deaerated to a predetermined purity is obtained, by opening the valve 110, the liquid W is sent to the dissolving unit 200 via the liquid discharge passage 106.

In FIG. 2, the preprocessing unit 100 that vaporizes a dissolved material by reducing the pressure of a gas including portion is shown, but the method of deaerating a dissolved liquid is not limited to this. For example, it may also be possible to adopt a heating/boiling method of vaporizing a dissolved material by boiling the liquid W, or a film deaeration method of increasing the interface between liquid and gas by using a hollow fiber. As the deaeration module using a hollow fiber, the SEPAREL series (made by DIC Corporation) is sold on the market. This is used for the purpose of deaerating air bubbles from ink that is supplied mainly to a piezo head by using poly 4-methylpentene-1 (PMP) as the material of the hollow fiber membrane. Further, it may also be possible to use two or more of a vacuum deaeration method, the heating/boiling method, and the film deaeration method at the same time.

By performing the deaeration processing as above as preprocessing, in a dissolving process described later, it is possible to increase the purity and solubility for the liquid W of desired gas. Further, in the T-UFB generation unit, to be described later, it is possible to increase the purity of a desired UFB included in the liquid W. That is, by providing the preprocessing unit 100 before the dissolving unit 200 and the T-UFB generation unit 300, it is made possible to efficiently generate the UFB-contained liquid of high purity.

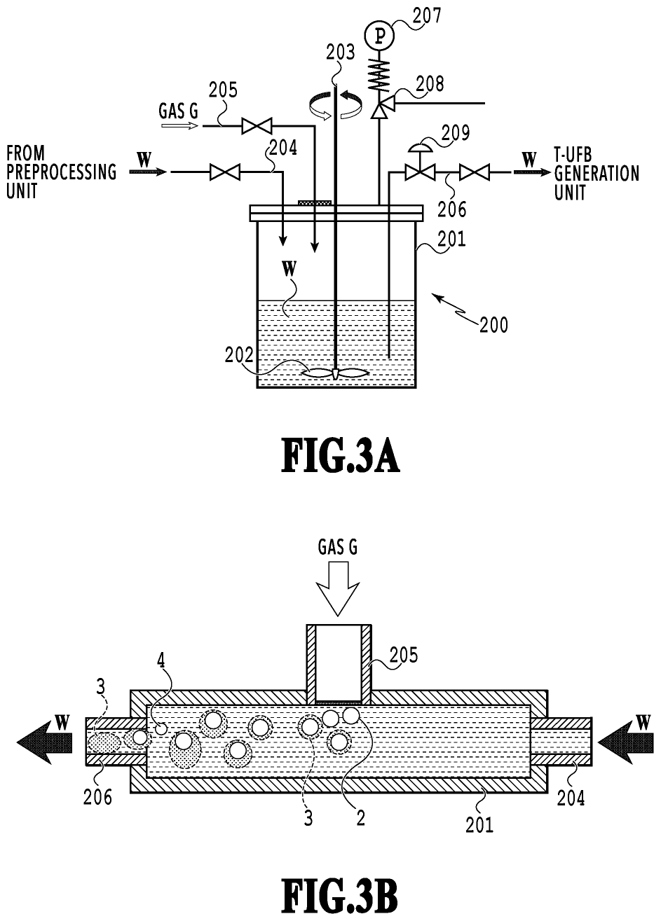

FIG. 3A and FIG. 3B are a schematic configuration diagram of the dissolving unit 200 and a diagram for explaining the dissolving state of a liquid, respectively. The dissolving unit 200 is a unit configured to dissolve desired gas in the liquid W supplied from the preprocessing unit 100. The dissolving unit 200 of the present embodiment mainly has a dissolving container 201, a rotation shaft 203 to which a rotation plate 202 is attached, a liquid introduction passage 204, a gas introduction passage 205, a liquid discharge passage 206, and a pressure pump 207.

The liquid W supplied from the preprocessing unit 100 is supplied to the dissolving container 201 through the liquid introduction passage 204 and stored therein. On the other hand, gas G is supplied to the dissolving container 201 through the gas introduction passage 205.

In a case where a predetermined amount of the liquid W and the gas G is stored in the dissolving container 201, the pressure pump 207 is activated and the internal pressure of the dissolving container 201 is increased to about 0.5 MPa. Between the pressure pump 207 and the dissolving container 201, a safety valve 208 is arranged. Further, by rotating the rotation plate 202 in the liquid via the rotation shaft 203, the gas G supplied to the dissolving container 201 is turned into air bubbles and dissolving into the liquid W is facilitated by increasing the contact area with the liquid W. Then, the work such as this is continued until the solubility of the gas G reaches substantially the maximum saturated solubility. At this time, in order to dissolve the gas as much as possible, it may also be possible to arrange a unit configured to reduce the temperature of the liquid. Further, in a case of an insoluble gas, it is also possible to increase the internal pressure of the dissolving container 201 to 0.5 MPa or higher. In that case, it is necessary to make optimum the material and the like of the container in view of safety.

In a case where the liquid W in which the component of the gas G is dissolved in a desired concentration is obtained, the liquid W is discharged via the liquid discharge passage 206 and supplied to the T-UFB generation unit 300. At this time, a back pressure valve 209 adjusts the flow pressure of the liquid W so that the pressure at the time of supply does not become higher than necessary.

FIG. 3B is a diagram schematically showing the way the gas G mixed in the dissolving container 201 is dissolved. An air bubble 2 including the component of the gas G mixed in the liquid W dissolves from the portion in touch with the liquid W. Because of this, the air bubble 2 gradually contracts and a state is brought about where a gas-dissolved liquid 3 exists around the air bubble 2. The buoyant force acts on the air bubble 2, and therefore, the air bubble 2 moves to a position deviated from the center of the gas-dissolved liquid 3, separates from the gas-dissolved liquid 3 and becomes a remaining air bubble 4, and so on. That is, in the liquid W that is supplied to the T-UFB generation unit 300 via the liquid discharge passage 206, a state where the air bubble 2 is surrounded by the gas-dissolved liquid 3 and a state where the gas-dissolved liquid 3 and the air bubble 2 are separate from each other exist in a mixed manner.

In FIG. 3B, the gas-dissolved liquid 3 means “an area in which the solubility concentration of the mixed gas G is comparatively high in the liquid W”. The concentration of the gas component actually dissolved in the liquid W is highest at the center of the area even in the state of being located around the air bubble 2 or of being separate from the air bubble 2 and as the gas component becomes more distant from the position, the concentration of the gas component becomes lower continuously. That is, in FIG. 3B, the area of the gas-dissolved liquid 3 is surrounded by a broken line for explanation, but in reality, the clear boundary such as this does not exist. Further, in the present embodiment, it is permitted for the gas that does not dissolve completely to exist in the liquid in a state of an air bubble.

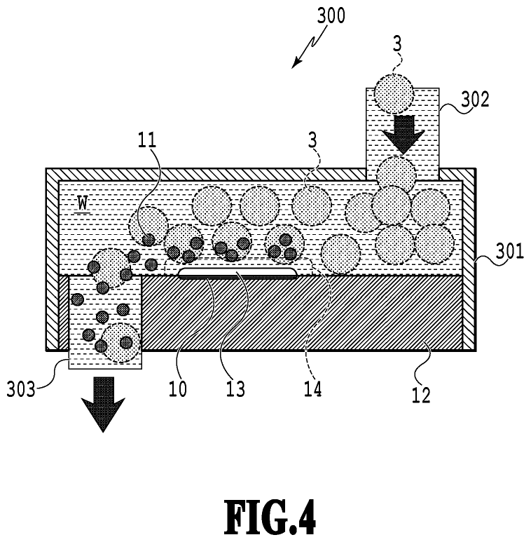

FIG. 4 is a schematic configuration diagram of the T-UFB generation unit 300. The T-UFB generation unit 300 mainly comprises a chamber 301, a liquid introduction passage 302, and a liquid discharge passage 303 and a flow from the liquid introduction passage 302 toward the liquid discharge passage 303 through the inside of the chamber 301 is formed by a flow pump, not shown schematically. As the flow pump, it is possible to adopt various pumps, such as a diaphragm pump, a gear pump, and a screw pump. In the liquid W that is introduced from the liquid introduction passage 302, the gas-dissolved liquid 3 of the gas G mixed by the dissolving unit 200 exists in a mixed manner.

At the bottom surface of the chamber 301, an element substrate 12 on which a heating element 10 is provided is arranged. By applying a predetermined voltage pulse to the heating element 10, a bubble 13 (in the following, also referred to as film boiling bubble 13) generated by film boiling occurs in the area that comes into contact with the heating element 10. Then, an ultra fine bubble (UFB 11) containing the gas G is generated accompanying expansion and contraction of the film boiling bubble 13. As a result of that, from the liquid discharge passage 303, the UFB-contained liquid W in which the many UFBs 11 are included is discharged.

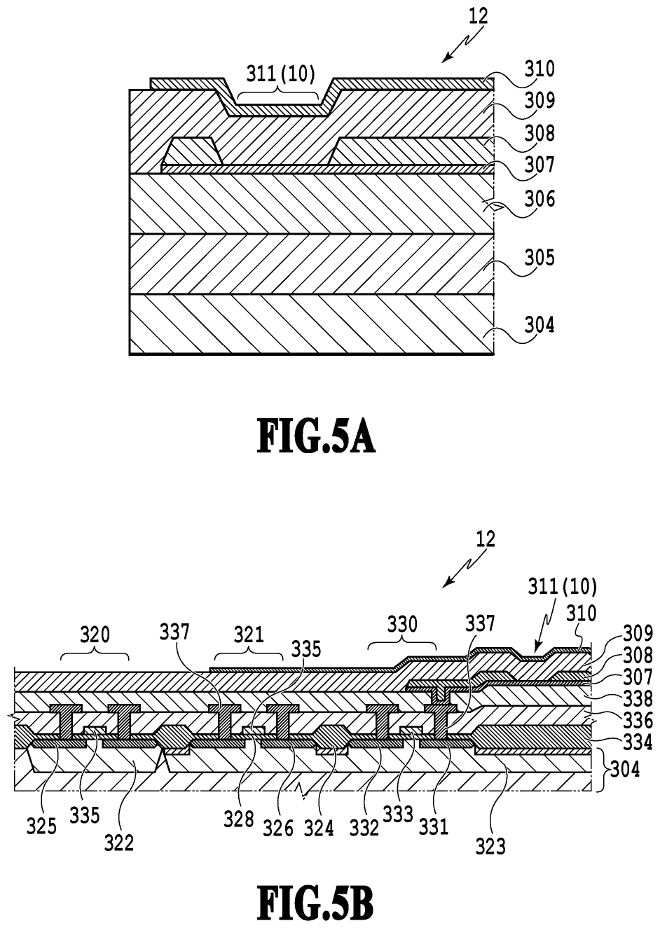

FIG. 5A and FIG. 5B are each a diagram showing a detailed structure of the heating element 10. FIG. 5A shows a cross-sectional diagram of the element substrate in the vicinity of the heating element 10 and FIG. 5B shows a cross-sectional diagram of the element substrate 12 in a wider area including the heating element 10, respectively.

As shown in FIG. 5A, in the element substrate 12 of the present embodiment, on the front surface of a silicon substrate 304, a thermal oxide film 305, as a heat storage layer, and an interlaminar film 306, which also functions as a heat storage layer, are laminated. As the interlaminar film 306, it is possible to use a SiO₂ film or a SiN film. On the front surface of the interlaminar film 306, a resistant layer 307 is formed and on the front surface of the resistant layer 307, a wire 308 is formed partially. As the wire 308, it is possible to use an Al alloy wire of Al, Al—Si, Al—Cu or the like. On the front surfaces of the wire 308, the resistant layer 307, and the interlaminar film 306, a protective layer 309 including a SiO₂ film or a Si₃N₄ film is formed.

On the front surface of the protective layer 309, at the portion corresponding to a heat acting portion 311, which eventually functions as the heating element 10, and on the periphery thereof, an anti-cavitation film 310 for protecting the protective layer 309 from the chemical and physical impacts accompanying heat generation of the resistant layer 307 is formed. On the front surface of the resistant layer 307, the area in which the wire 308 is not formed is the heat acting portion 311 at which the resistant layer 307 generates heat. The heat generation portion of the resistant layer 307 at which the wire 308 is not formed functions as the heating element (heater) 10. As described above, the layers in the element substrate 12 are formed sequentially on the front surface of the silicon substrate 304 by the semiconductor manufacturing technique and due to this, the silicon substrate 304 is provided with the heat acting portion 311.

The configuration shown in FIG. 5A is an example and it is possible to apply other various configurations. For example, it is possible to apply a configuration in which the lamination order of the resistant layer 307 and the wire 308 is opposite and a configuration (so-called plug electrode configuration) in which an electrode is connected to the lower surface of the resistant layer 307. That is, as will be described later, the configuration is only required to be one in which it is possible to cause film boiling to take place in a liquid by heating the liquid by the heat acting portion 311.

FIG. 5B is an example of the cross-sectional diagram of the area including the circuit that is connected to the wire 308 in the element substrate 12. On the front layer of the silicon substrate 304, which is a P-type electric conductor, an N-type well area 322 and a P-type well area 323 are provided partially. By introduction and diffusion of impurities, such as ion implantation by a general MOS process, a P-MOS 320 is formed in the N-type well area 322 and an N-MOS 321 is formed in the P-type well area 323.

The P-MOS 320 includes a source area 325 and a drain area 326, which are formed by introducing N-type or P-type impurities partially into the front layer of the N-type well area 322, a gate wire 335 and the like. The gate wire 335 is deposited via a gate insulation film 328 having a thickness of several hundred A on the front surface of the portion of the N-type well area 322 except for the source area 325 and the drain area 326.

The N-MOS 321 includes the source area 325 and the drain area 326, which are formed by introducing N-type or P-type impurities partially into the front layer of the P-type well area 323, the gate wire 335 and the like. The gate wire 335 is deposited via the gate insulation film 328 having a thickness of several hundred A on the front surface of the portion of the P-type well area 323 except for the source area 325 and the drain area 326. The gate wire 335 includes polysilicon having a thickness of 3,000 Å to 5,000 Å deposited by the CVD method. By the P-MOS 320 and the N-MOS 321, a C-MOS logic is configured.

In the P-type well area 323, at the portion different from the N-MOS 321, an N-MOS transistor 330 for driving an electrothermal conversion element (heating resistance element) is formed. The N-MOS transistor 330 includes a source area 332 and a drain area 331, which are formed partially on the front layer of the P-type well area 323 by the process, such as introduction and diffusion of impurities, a gate wire 333 and the like. The gate wire 333 is deposited via the gate insulating film 328 on the front surface of the portion except for the source area 332 and the drain area 331 in the P-type well area 323.

In this example, as the transistor for driving the electrothermal conversion element, the N-MOS transistor 330 is used. However, the driving transistor may be any transistor having the capacity to individually drive a plurality of electrothermal conversion elements and capable of obtaining the fine structure as described above and is not limited to the N-MOS transistor 330. Further, in this example, the electrothermal conversion element and the driving transistor thereof are formed on the same substrate, but it may also be possible to form these on separate substrates.

Between each element, such as between the P-MOS 320 and the N-MOS 321 and between the N-MOS 321 and the N-MOS transistor 330, an oxide film separation area 324 having a thickness of 5,000 Å to 10,000 Å is formed by field oxidation. By this oxide film separation area 324, each element is separated. In the oxide film separation area 324, the portion corresponding to the heat acting portion 311 functions as a first heat storage layer 334 on the silicon substrate 304.

On the front surface of each element of the P-MOS 320, the N-MOS 321, and the N-MOS transistor 330, an interlayer insulating film 336 including a PSG film having a thickness of about 7,000 Å, a BPSG film or the like is formed by the CVD method. After flattening the interlayer insulating film 336 by heat processing, an Al electrode 337 that becomes a first wire layer is formed via a contact hole penetrating through the interlayer insulating film 336 and the gate insulating film 328. On the front surfaces of the interlayer insulating film 336 and the Al electrode 337, an interlayer insulating film 338 including a SiO₂ film having a thickness of 10,000 Å to 15,000 Å is formed by the plasma CVD method. On the front surface of the interlayer insulating film 338, at the portion corresponding to the heat acting portion 311 and the N-MOS transistor 330, the resistant layer 307 including a TaSiN film having a thickness of about 500 Å is formed by the cosputter method. The resistant layer 307 is electrically connected with the Al electrode 337 in the vicinity of the drain area 331 via a through hole formed in the interlayer insulating film 338. On the front surface of the resistant layer 307, the Al wire 308 as s second wire layer that becomes a wire to each electrothermal conversion element is formed. The protective layer 309 on the front surfaces of the wire 308, the resistant layer 307, and the interlayer insulating film 338 includes a SiN film having a thickness of 3,000 Å formed by the plasma CVD method. The anti-cavitation film 310 deposited on the front surface of the protective layer 309 is at least one or more metals selected from Ta, Fe, Ni, Cr, Ge, Ru, Zr, Ir and the like and includes a thin film having a thickness of about 2,000 Å. As the resistant layer 307, it is possible to apply various materials capable of causing film boiling to take place in a liquid, such as TaN_{0.8}, CrSiN, TaAl, WSiN and the like other than TaSiN described above.

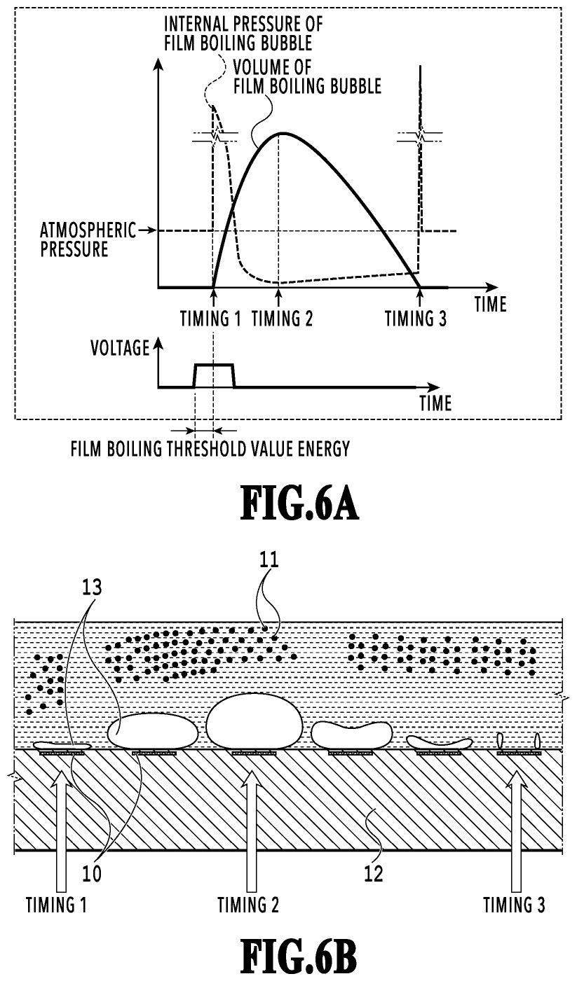

FIG. 6A and FIG. 6B are each a diagram showing the state of film boiling in a case where a predetermined voltage pulse is applied to the heating element 10. Here, a case where film boiling is caused to take place under the atmospheric pressure is shown. In FIG. 6A, the horizontal axis represents time. Further, the vertical axis of the graph at the lower portion represents the voltage that is applied to the heating element 10 and the vertical axis of the graph at the upper portion represents the volume and the internal pressure of the film boiling bubble 13 that occurs by film boiling. On the other hand, FIG. 6B shows the state of the film boiling bubble 13 in association with timing 1 to timing 3 shown in FIG. 6A. In the following, each state is explained along time.

Before a voltage is applied to the heating element 10, substantially the atmospheric pressure is kept within the chamber 301. In a case where a voltage is applied to the heating element 10, film boiling takes place in the liquid in contact with the heating element 10 and the air bubble (in the following, referred to as film boiling bubble 13) having occurred expands by a high pressure that acts from the inside (timing 1). The foaming pressure at this time is regarded as about 8 to 10 MPa and this is close to the value of the saturated vapor pressure of water.

The voltage application time (pulse width) is about 0.5 pec to 10.0 μsec, but even after the voltage is no longer applied, the film boiling bubble 13 expands by the inertia of the pressure obtained at timing 1. However, inside the film boiling bubble 13, the negative pressure having occurred accompanying the expansion gradually becomes large and acts in the direction in which the film boiling bubble 13 contracts. Then, after a while, at timing 2 at which the inertial force and the negative pressure become in equilibrium, the volume of the film boiling bubble 13 reaches the maximum and after that, the film boiling bubble 13 contracts rapidly by the negative pressure.

At the time of the film boiling bubble 13 becoming extinct, the film boiling bubble 13 does not become extinct at the entire surface of the heating element 10 but becomes extinct in a very small area at one or more portions. Because of this, in the heating element 10, in the very small area in which the film boiling bubble 13 becomes extinct, a force larger than that at the time of foaming indicated by timing 1 occurs (timing 3).

The occurrence, expansion, contraction, and extinction of the film boiling bubble 13 as explained above are repeated each time the voltage pulse is applied to the heating element 10 and the new UFB 11 is generated each time.

Next, the way the UFB 11 is generated in each process of the occurrence, expansion, contraction, and extinction of the film boiling bubble 13 is explained in more detail.

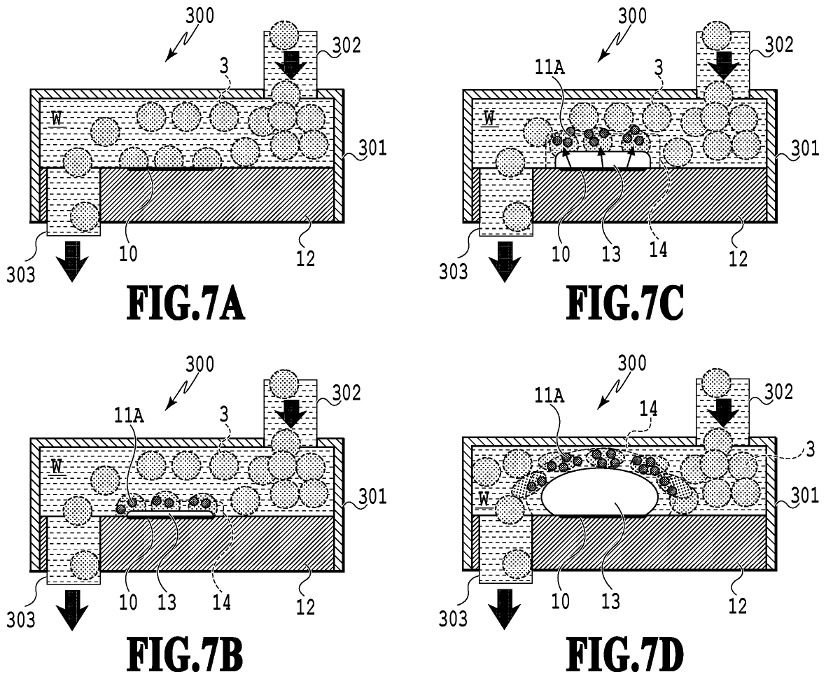

FIG. 7A to FIG. 7D are diagrams showing the way the UFB 11 is generated accompanying the occurrence and expansion of the film boiling bubble 13. FIG. 7A shows the state before the voltage pulse is applied to the heating element 10. Inside the chamber 301, the liquid W in which the gas-dissolved liquid 3 exists in a mixed manner flows.

FIG. 7B shows the way the voltage is applied to the heating element 10 and the film boiling bubble 13 has occurred uniformly almost in the entire area of the heating element 10 in contact with the liquid W. In a case where the voltage is applied, the surface temperature of the heating element 10 rises rapidly at a speed higher than or equal to 10° C./μsec and at the point in time at which about 300° C. is reached, film boiling takes place and the film boiling bubble 13 is generated.

The surface temperature of the heating element 10 rises up to about 600 to 800° C. during the application of the pulse after that as well and the liquid on the periphery of the film boiling bubble 13 is also heated rapidly. In FIG. 7B, the area of the liquid that is located on the periphery of the film boiling bubble 13 and which is heated rapidly is shown as an un-foamed high-temperature area 14. The gas-dissolved liquid 3 included in the un-foamed high-temperature area 14 exceeds the thermal solubility limit and precipitates to become the UFB. The diameter of the precipitated air bubble is about 10 nm to 100 nm and has high gas-liquid interface energy. Because of this, the air bubble does not become extinct in a short time and floats while keeping independence within the liquid W. In the present embodiment, the air bubble that is generated by the thermal action at the time of expansion of the film boiling bubble 13 in this manner is referred to as a first UFB 11A.

FIG. 7C shows the process in which the film boiling bubble 13 expands. Even though the application of the voltage pulse to the heating element 10 is terminated, the film boiling bubble 13 continues to expand by the inertia of the force obtained at the time of occurrence and the un-foamed high-temperature area 14 also moves and diffuses by the inertia. That is, in the process in which the film boiling bubble 13 expands, the gas-dissolved liquid 3 included in the un-foamed high-temperature area 14 becomes an air bubble anew and precipitates to become the first UFB 11A.

FIG. 7D shows the state where the volume of the film boiling bubble 13 has reached the maximum. The film boiling bubble 13 expands by the inertia, but the negative pressure inside the film boiling bubble 13 gradually increases accompanying the expansion and acts as the negative pressure that tries to contract the film boiling bubble 13. Then, at the point in time at which this negative pressure and the inertial force become in equilibrium, the volume of the film boiling bubble 13 reaches the maximum and after that, the film boiling bubble 13 begins to contract.

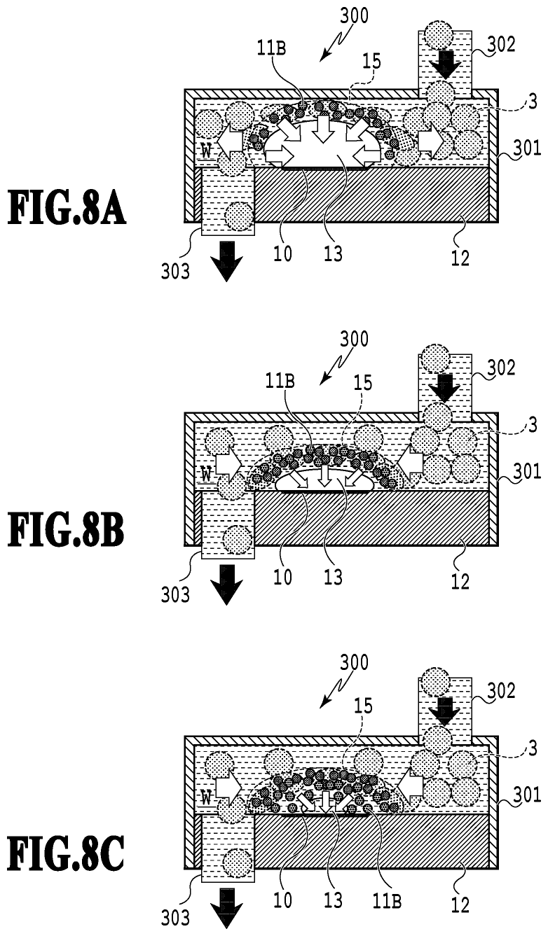

FIG. 8A to FIG. 8C are diagrams showing the way the UFB 11 is generated accompanying the contraction of the film boiling bubble 13. FIG. 8A shows the state where the film boiling bubble 13 has begun to contract. Even though the film boiling bubble 13 has begun to contract, the inertial force in the direction of expansion remains in the liquid W on the periphery. Consequently, on the close periphery of the film boiling bubble 13, the inertial force that acts in the direction of becoming distant from the heating element 10 and the force in the direction of becoming close to the heating element 10 accompanying the contraction of the film boiling bubble 13 act and the area becomes the depressurized area. In FIG. 8A, the area such as this is shown as an un-foamed negative pressure area 15.

The gas-dissolved liquid 3 included in the un-foamed negative pressure area 15 exceeds the pressure solubility limit and precipitates as an air bubble. The diameter of the precipitated air bubble is about 100 nm and does not become extinct in a short time after that and floats while keeping independence within the liquid W. In the present embodiment, the air bubble that precipitates in this manner by the pressure action at the time of contraction of the film boiling bubble 13 is referred to as a second UFB 11B.

FIG. 8B shows the process in which the film boiling bubble 13 contracts. The speed at which the film boiling bubble 13 contracts is increased by the negative pressure and the un-foamed negative pressure area 15 also moves accompanying the contraction of the film boiling bubble 13. That is, in the process in which the film boiling bubble 13 contracts, the gas-dissolved liquid 3 at the portion at which the un-foamed negative pressure area 15 passes precipitates one after another and becomes the second UFB 11B.

FIG. 8C shows the state immediately before the film boiling bubble 13 becomes extinct. By the accelerating contraction of the film boiling bubble 13, the moving speed of the liquid W on the periphery increases, but the pressure loss occurs due to the flow passage resistance within the chamber 301. As a result of that, the area occupied by the un-foamed negative pressure area 15 becomes further larger and the many second UFBs 11B are generated.

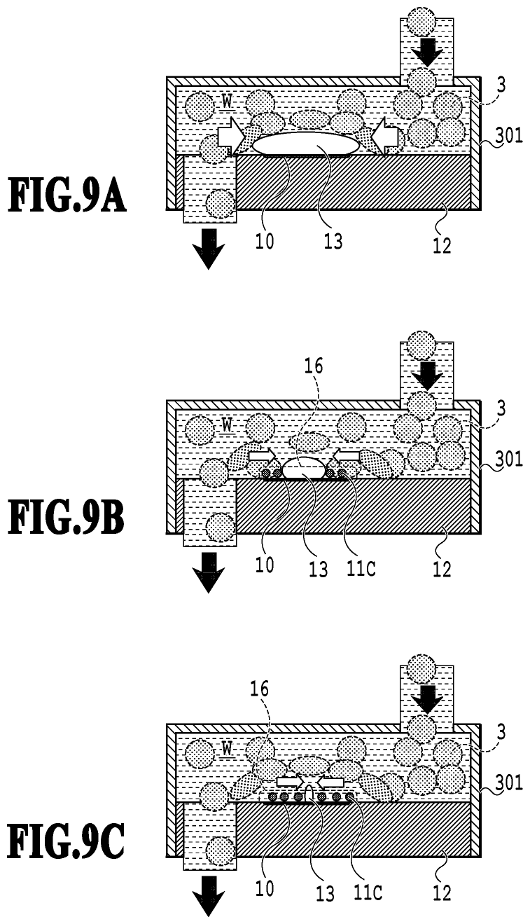

FIG. 9A to FIG. 9C are diagrams showing the way the UFB is generated by reheating of the liquid W at the time of contraction of the film boiling bubble 13. FIG. 9A shows the state where the front surface of the heating element 10 is covered by the film boiling bubble 13 that contracts.

FIG. 9B shows the state where the contraction of the film boiling bubble 13 advances and part of the front surface of the heating element 10 is in contact with the liquid W. On the front surface of the heating element 10 at this time, heat remains, whose amount does not cause film boiling to take place even in a case where the liquid W comes into contact with the front surface. In FIG. 9B, the area of the liquid that is heated in a case of coming into contact with the front surface of the heating element 10 is shown as an un-foamed reheated area 16. Although film boiling is not caused to take place, the gas-dissolved liquid 3 included in the un-foamed reheated area 16 exceeds the thermal solubility limit and precipitates. In the present embodiment, the air bubble that is generated in this manner by reheating of the liquid W at the time of contraction of the film boiling bubble 13 is referred to as a third UFB 11C.

FIG. 9C shows the state where the contraction of the film boiling bubble 13 has further advanced. The smaller the film boiling bubble 13 becomes, the larger the area of the heating element 10 that comes into contact with the liquid W becomes, and therefore, the third UFB 11C is generated until the film boiling bubble 13 becomes extinct.

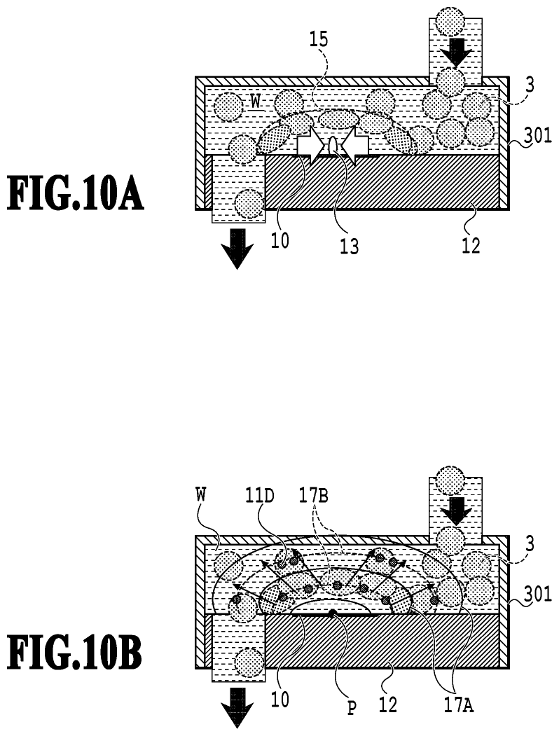

FIG. 10A and FIG. 10B are diagrams showing the way the UFB is generated by an impact (a kind of so-called cavitation) at the time of disappearance of the film boiling bubble 13 generated by film boiling. FIG. 10A shows the state immediately before the film boiling bubble 13 becomes extinct. The film boiling bubble 13 contracts rapidly by the internal negative pressure and the state is such that the un-foamed negative pressure area 15 covers the periphery of the film boiling bubble 13.

FIG. 10B shows the state immediately after the film boiling bubble 13 has become extinct at a point P. At the time of disappearance of the film boiling bubble 13, an acoustic wave spreads concentrically by the impact with the point P as a starting point. The acoustic wave is the general term of the elastic wave that propagates irrespective of gas, liquid, and solid and in the present embodiment, the non-uniformity of the liquid W, that is, a high-pressure surface 17A and a low-pressure surface 17B of the liquid W propagate alternately.

In this case, the gas-dissolved liquid 3 included in the un-foamed negative pressure area 15 is resonated by the impact wave at the time of disappearance of the film boiling bubble 13 and at the timing at which the low-pressure surface 17B passes, the gas-dissolved liquid 3 exceeds the pressure solubility limit and makes a phase transition. That is, at the same time as the extinction of the film boiling bubble 13, many air bubbles precipitate within the un-foamed negative pressure area 15. In the present embodiment, the air bubble such as this, which is generated by the impact wave at the time of disappearance of the film boiling bubble 13, is referred to as a fourth UFB 11D.

The fourth UFB 11D that is generated by the impact wave at the time of disappearance of the film boiling bubble 13 appears suddenly in a very short time (less than or equal to 1 μS) in a very narrow thin film area. The diameter is sufficiently smaller than those of the first to third UFBs and the gas-liquid interface energy is higher than those of the first to third UFBs. Because of this, it is considered that the fourth UFB 11D has a characteristic different from those of the first UFB 11A to the third UFB 11C and produces a different effect.

Further, the fourth UFB 11D occurs uniformly at many portions in the concentric sphere-shaped area in which the impact wave propagates, and therefore, the fourth UFB 11D exists uniformly within the chamber 301 from the time in point of generation. At the timing at which the fourth UFB 11D is generated, the first to third UFBs already exist in a large number, but it is unlikely that the existence of these first to third UFBs largely affects the generation of the fourth UFB 11D. Further, it is also unlikely that the occurrence of the fourth UFB 11D causes the first to third UFBs to become extinct.

As explained above, the FUB 11 occurs in a plurality of stages from the occurrence of the film boiling bubble 13 by the heat generation of the heating element 10 until the disappearance of the film boiling bubble 13. In the example described above, the example until the film boiling bubble 13 disappears is shown, but the example in which the UFB is generated is not limited to this. For example, it is possible to generate the UFB also in a case where the film boiling bubble 13 does not disappear by communicating with the atmosphere before the generated film boiling bubble 13 disappears.

Next, a survival characteristic of the UFB is explained. The higher the temperature of the liquid, the lower the solubility characteristic of the gas component is and the lower the temperature, the higher the solubility characteristic of the gas component is. That is, the higher the temperature of the liquid, the more likely the phase transition of the dissolved gas component is facilitated and the UFB becomes more likely to be generated. The liquid temperature and the gas solubility are in an inversely proportional relationship and by the rise in the liquid temperature, the gas having exceeded the saturated solubility becomes an air bubble and precipitates into the liquid.

Because of this, in a case where the liquid temperature rises rapidly from the normal temperature, the solubility characteristic drops immediately and the UFB begins to be generated. Then, as the temperature rises, the thermal solubility characteristic becomes low and the situation in which the many UFBs are generated is brought about.

On the contrary, in a case where the liquid temperature drops from the normal temperature, the gas solubility characteristic becomes high and the generated UFB becomes more likely to liquefy. However, the temperature such as this is sufficiently lower than the normal temperature. Further, even though the liquid temperature drops, the UFB having occurred once has a high internal pressure and high gas-liquid interface energy, and therefore, the possibility that a pressure high enough to destroy the gas-liquid interface acts is very faint. That is, the UFB having been generated once does not simply become extinct as long as the liquid is preserved at the normal temperature and pressure.

In the present embodiment, it can be said that the first UFB 11A explained in FIG. 7A to FIG. 7C and the third UFB 11C explained in FIG. 9A to FIG. 9C are the UFBs generated by utilizing the thermal solubility characteristic of the gas such as this.

On the other hand, in the relationship between the liquid pressure and the solubility characteristic, the higher the liquid pressure, the higher the gas solubility characteristic is and the lower the pressure, the lower the solubility characteristic is. That is, the lower the liquid pressure, the more likely the phase transition of the gas-dissolved liquid dissolved in the liquid into gas is facilitated, and therefore, the UFB becomes more likely to be generated. In a case where the liquid pressure drops from the normal pressure, the solubility characteristic becomes low immediately and the UFB begins to be generated. Then, as the pressure drops, the pressure solubility characteristic becomes low and the situation in which the many UFBs are generated is brought about.

On the contrary, in a case where the liquid pressure rises from the normal pressure, the gas solubility characteristic becomes high and the generated UFB becomes more likely to liquefy. However, the pressure such as this is sufficiently higher than the atmospheric pressure and further, even though the liquid pressure rises, the UFB having occurred once has a high internal pressure and high gas-liquid interface energy, and therefore, the possibility that a pressure high enough to destroy the gas-liquid interface acts is very faint. That is, the UFB having been generated once does not simply become extinct as long as the liquid is preserved at the normal temperature and pressure.

In the present embodiment, it can be said that the second UFB 11B explained in FIG. 8A to FIG. 8C and the fourth UFB 11D explained in FIG. 10A and FIG. 10B are the UFBs generated by utilizing the pressure solubility characteristic of the gas such as this.

In the above, the first to fourth UFBs whose generation factors are different are explained individually, but the above-described generation factors occur simultaneously at many portions accompanying the event, that is, the film boiling. Because of this, there is a case where at least two or more kinds of UFB among the first to fourth UFBs are generated at the same time or a case where the UFB is generated by the cooperation of these generation factors with one another. However, it is common to all the generation factors that these generation factors are brought about by the film boiling phenomenon. In the following, in the present specification, the method of generating the UFB by utilizing film boiling accompanying the rapid heat generation such as this is referred to as the T-UFB (Thermal-Ultra Fine Bubble) generation method. Further, the UFB generated by the T-UFB generation method is referred to as T-UFB and the liquid containing the T-UFB generated by the T-UFB generation method is referred to as T-UFB-contained liquid.

Almost all the air bubbles generated by the T-UFB generation method have a diameter of 1.0 μm or less and the milli bubble and the micro bubble are unlikely to be generated. That is, according to the T-UFB generation method, only the UFB is generated efficiently. Further, the T-UFB that is generated by the T-UFB generation method has higher gas-liquid interface energy than that of the UFB generated by the conventional method and does not simply become extinct as long as being preserved at the normal temperature and pressure. Furthermore, even in a case where a new T-UFB is generated by new film boiling, it is unlikely that the T-UFB generated previously becomes extinct because of the impact thereof. That is, it can be said that the number of T-UFBs included in the T-UFB-contained liquid and the concentration thereof have the hysteresis characteristic for the number of times of occurrence of film boiling in the T-UFB-contained liquid. In other words, it is possible to adjust the concentration of the T-UFB included in the T-UFB-contained liquid by controlling the number of heating elements arranged in the T-UFB generation unit 300 and the number of times of application of the voltage pulse to the heating element.

FIG. 1 is referred to again. In a case where the T-UFB-contained liquid W having a desired UFB concentration is generated in the T-UFB generation unit 300, the T-UFB-contained liquid W is supplied to the post-processing unit 400.

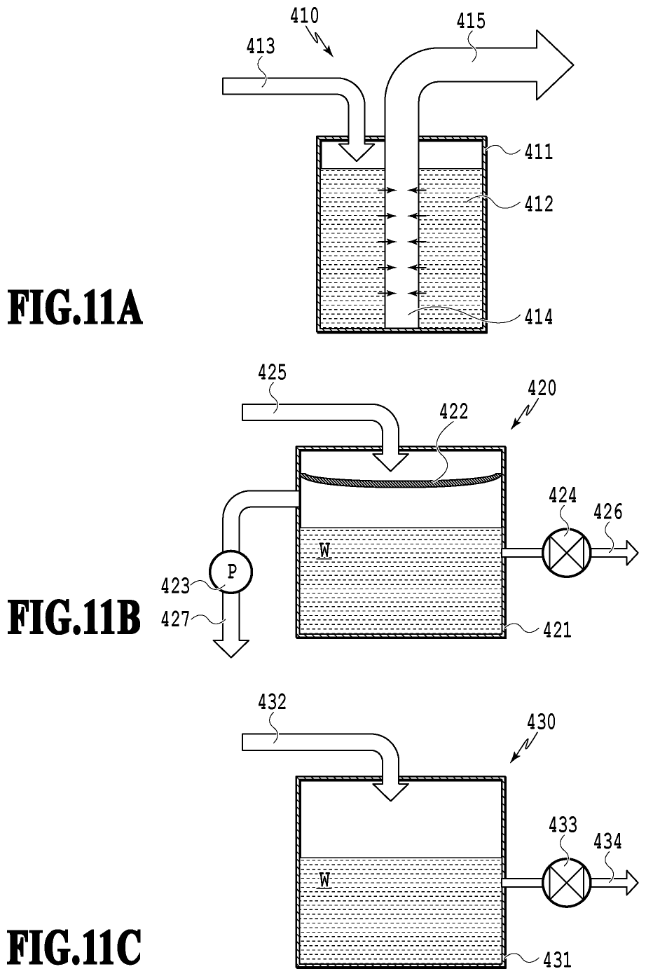

FIG. 11A to FIG. 11C are each a diagram showing a configuration example of the post-processing unit 400 of the present embodiment. The post-processing unit 400 of the present embodiment removes impurities included in the UFB-contained liquid W stepwise in order of inorganic ions, organic matter, and insoluble solid bodies.

FIG. 11A shows a first post-processing mechanism 410 for removing inorganic ions. The first post-processing mechanism 410 comprises an exchange container 411, a cation exchange resin 412, a liquid introduction passage 413, a water collection pipe 414, and a liquid discharge passage 415. In the exchange container 411, the cation exchange resin 412 is accommodated. The UFB-contained liquid W generated in the T-UFB generation unit 300 is injected into the exchange container 411 via the liquid introduction passage 413, absorbed by the cation exchange resin 412, and cations as impurities are removed here. The impurities such as these include metal materials that flake off from the element substrate 12 of the T-UFB generation unit 300 and the like and mention is made of, for example, SiO₂, SiN, SiC, Ta, Al₂O₃, Ta₂O₅, Ir and the like.

The cation exchange resin 412 is a synthetic resin obtained by introducing the functional group (ion exchange group) into the high molecular matrix having a three-dimensional mesh structure and the synthetic resin exhibits a spherical particle having a diameter of about 0.4 to 0.7 mm. The high molecular matrix is generally a copolymer of styrene-divinylbenzene and as the functional group, for example, it is possible to use the methacrylic acid-based functional group or the acrylic acid-based functional group. However, the above-described materials are examples. As long as it is possible to effectively remove desired inorganic ions, the above-described materials can be changed in a variety of ways. The UFB-contained liquid W absorbed by the cation exchange resin 412 and from which inorganic ions are removed are collected by the water collection pipe 414 and sent to the next process via the liquid discharge passage 415.

FIG. 11B shows a second post-processing mechanism 420 for removing organic matter. The second post-processing mechanism 420 comprises an accommodation container 421, a filtration filter 422, a vacuum pump 423, a valve 424, a liquid introduction passage 425, a liquid discharge passage 426, and an air suction passage 427. The inside of the accommodation container 421 is divided into two areas, that is, an upper area and a lower area, by the filtration filter 422. The liquid introduction passage 425 connects to the upper area of the two upper and lower areas and the air suction passage 427 and the liquid discharge passage 426 connect to the lower area. In a case where the vacuum pump 423 is driven in the state where the valve 424 is closed, the air within the accommodation container 421 is discharged via the air suction passage 427 and the pressure of the inside of the accommodation container 421 becomes a negative pressure and the UFB-contained liquid W is introduced through the liquid introduction passage 425. Then, the UFB-contained liquid W in the state where impurities are removed by the filtration filter 422 is stored in the accommodation container 421.

The impurities that are removed by the filtration filter 422 include organic materials that can be mixed in a tube or each unit and mention is made of, for example, organic compounds including silicon, siloxane, epoxy and the like. As the filter film that can be used as the filtration filter 422, mention is made of a sub micrometer mesh filter capable of removing microorganisms as small as bacteria and a nanometer mesh filter capable of removing microorganisms as small as viruses.

After a certain amount of the UFB-contained liquid W is stored in the accommodation container 421, in a case where the vacuum pump 423 is stopped and the valve 424 is opened, the T-UFB-contained liquid in the accommodation container 421 is sent to the next process via the liquid discharge passage 426. Here, as the method of removing impurities of organic matter, the vacuum filtration method is adopted, but as the filtration method using a filter, it is also possible to adopt, for example, the gravity filtration method or the pressure filtration method.

FIG. 11C shows a third post-processing mechanism 430 for removing insoluble solid bodies. The third post-processing mechanism 430 comprises a precipitation container 431, a liquid introduction passage 432, a valve 433, and a liquid discharge passage 434.

First, in the state where the valve 433 is closed, a predetermined amount of the UFB-contained liquid W is stored in the precipitation container 431 through the liquid introduction passage 432 and this state is left as it is for a while. During this time, the solid bodies included in the UFB-contained liquid W precipitate onto the bottom of the precipitation container 431 by the gravity. Further, among the bubbles included in the UFB-contained liquid, the bubble whose size is comparatively large, such as the micro bubble, floats up to the liquid surface by the buoyant force and is removed from the UFB-contained liquid. In a case where the valve 433 is opened after a sufficiently long time elapses, the UFB-contained liquid W from which solid bodies and large-size bubbles have been removed is sent to the collection unit 500 via the liquid discharge passage 434.

FIG. 1 is referred to again. It may also be possible to send the T-UFB-contained liquid W from which impurities have been removed by the post-processing unit 400 to the collection unit 500 as it is, but it is also possible to return it again to the dissolving unit 200. In a case of the latter, it is possible to increase the gas solubility concentration of the T-UFB-contained liquid W, which has dropped by the generation of the T-UFB, to the saturated state again in the dissolving unit 200. After that, in a case where a new T-UFB is generated by the T-UFB generation unit 300, under the above-described characteristic, it is possible to further increase the UFB content concentration of the T-UFB-contained liquid. That is, it is possible to increase the UFB content concentration by an amount corresponding to the number of times of circulation through the dissolving unit 200, the T-UFB generation unit 300, and the post-processing unit 400 and after a desired UFB content concentration is obtained, it is possible to send the UFB-contained liquid W to the collection unit 500.

Here, the effect of returning the generated T-UFB-contained liquid W to the dissolving unit 200 again is explained briefly in accordance with the verification contents obtained by the inventors of the present invention performing specific verification. First, in the T-UFB generation unit 300, the 10,000 heating elements 10 were arranged on the element substrate 12. As the liquid W, industrial pure water was used and the industrial pure water was caused to flow through the chamber 301 of the T-UFB generation unit 300 at a flow rate of 1.0 liter/hour. In this state, a voltage pulse whose voltage is 24 V and whose pulse width is 1.0 μs was applied to each heating element at a drive frequency of 10 KHz.

In a case where the generated T-UFB-contained liquid W was collected by the collection unit 500 instead of returning it to the dissolving unit 200, that is, the number of times of circulation was set to one, in the T-UFB-contained liquid W collected by the collection unit 500, 3.6 billion UFBs were detected in 1.0 mL. On the other hand, in a case where the operation to return the T-UFB-contained liquid W to the dissolving unit 200 was performed nine times, that is, the number of times of circulation was set to ten, in the T-UFB-contained liquid W collected by the collection unit 500, 36 billion UFBs were detected in 1.0 mL. That is, it was confirmed that the UFB content concentration becomes higher in proportion to the number of times of circulation. The number density of UFBs as described above was obtained by counting the UFBs whose diameter is less than 1.0 μm included in the UFB-contained liquid W having a predetermined volume using the measuring instrument (model number SALD-7500) made by Shimadzu Corporation.

The collection unit 500 collects and preserves the UFB-contained liquid W sent from the post-processing unit 400. The T-UFB-contained liquid collected by the collection unit 500 is a UFB-contained liquid of high purity from which various impurities have been removed.

In the collection unit 500, it may also be possible to perform the filtering processing in several stages and classify the UFB-contained liquid W according to T-UFB size. Further, it is predicted that the T-UFB-contained liquid W obtained by the T-UFB generation method has a temperature higher than the normal temperature, and therefore, it may also be possible to provide a cooling unit in the collection unit 500. It may also be possible to provide the cooling unit such as this in part of the post-processing unit 400.

The above is the outline of the UFB generation apparatus 1 and it is of course possible to change the plurality of units as shown schematically and it is not necessary to prepare all the units. It may also be possible to omit part of the above-described units in accordance with the kind of the liquid W and the gas G that are used or the purpose of use of the T-UFB-contained liquid that is generated, and it may also be possible to further add another unit other than the above-described units.

For example, in a case where the gas that is contained in the UFB is the atmosphere, it is possible to omit the preprocessing unit 100 and the dissolving unit 200. On the contrary, in a case where it is desired to contain a plurality of kinds of gas in the UFB, it may also be possible to further add the dissolving unit 200.

Further, it is also possible to integrate the functions of the several units shown in FIG. 1 into one unit. For example, by arranging the heating element 10 in the dissolving container 201 shown in FIG. 3A and FIG. 3B, it is possible to integrate the dissolving unit 200 and the T-UFB generation unit 300. Specifically, the T-UFB module of electrode type is incorporated within the gas dissolving container (high-pressure chamber) and a plurality of heaters arranged within the module is driven, and film boiling is caused to take place. By doing this, it is possible to generate the T-UFB containing the gas while dissolving the gas in one unit. In this case, by arranging the T-UFB module at the bottom of the gas dissolving container, the heat generated by the heaters causes Marangoni convection to take place, and therefore, it is possible to stir the liquid within the container to a certain extent without the need to provide a circulation/stirring unit.

Further, it may also be possible to provide the removal unit for removing impurities as shown in FIG. 11A to FIG. 11C at the upstream of the T-UFB generation unit 300 as part of the preprocessing unit or provide it at both the upstream and the downstream. In a case where the liquid that is supplied to the UFB generation apparatus is tap water, rainwater, contaminated water or the like, it may happen that organic-based or inorganic-based impurities are included in the liquid. In a case where the liquid W including the impurities such as those is supplied to the T-UFB generation unit 300, there is a possibility that the heating element 10 degenerates or a salting-out phenomenon is brought about. By providing the mechanisms as shown in FIG. 11A to FIG. 11C at the upstream of the T-UFB generation unit 300, it is made possible to remove in advance the impurities as described above and generate the UFB-contained liquid of higher purity more efficiently.

In particular, in a case where the impurity removal unit by an ion exchange resin, which is shown in FIG. 11A, is provided in the preprocessing unit, arranging an anion exchange resin will contribute to efficient generation of the T-UFB water. The reason is that it has been confirmed that the ultra fine bubble that is generated by the T-UFB generation unit 300 has negative charges. Consequently, by removing impurities having the same negative charges in the preprocessing unit, it is possible to generate T-UFB water of high purity. As the anion exchange resin that is used here, both the strongly basic anion exchange resin having the quaternary ammonium group and the weakly basic anion exchange resin having the primary to tertiary amine groups are suitable. Which is more suitable depends on the kind of liquid that is used. Normally, in a case where tap water or pure water is used as a liquid, it is possible to perform the impurity removal function sufficiently by the latter weakly basic anion exchange resin alone.

<<Liquid and Gas that can be Used for T-UFB-Contained Liquid>>

Here, the liquid W that can be used for generating the T-UFB-contained liquid is explained. As the liquid W that can be used in the present embodiments, mention is made of, for example, pure water, deionized water, distilled water, bioactive water, magnetically activated water, lotion, tap water, seawater, river water, service and waste water, lake water, groundwater, rain water and the like. Further, it is also possible to use a mixed liquid including these liquids and the like. Furthermore, it is also possible to use a mixed solvent of water and a water-soluble organic solvent. The water-soluble organic solvent that is used by being mixed with water is not limited in particular and as specific examples, mention is made of as follows. Alkyl alcohols whose carbon number is 1 to 4, such as methyl alcohol, ethyl alcohol, n-propyl alcohol, isopropyl alcohol, n-butyl alcohol, sec-butyl alcohol, and tert-butyl alcohol. Amides, such as N-methyl-2-pyrrolidone, 2-pyrrolidone, 1, 3-dimethyl-2-imidazolidinone, N, N-dimethylformamide, and N, N-dimethylacetamide. Ketone or ketoalcohols, such as acetone and diacetone alcohol. Cyclic ethers, such as tetrahydrofuran and dioxane. Glycols, such as ethylene glycol, 1, 2-propylene glycol, 1, 3-propylene glycol, 1, 2-butanediol, 1, 3-butanediol, 1, 4-butanediol, 1, 5-pentanediol, 1, 2-hexanediol, 1, 6-hexanediol, 3-methyl-1, 5-pentanediol, diethylene glycol, triethylene glycol, and thiodiglycol. Lower alkyl ethers of multivalent alcohols, such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether. Polyalkylene glycols, such as polyethylene glycol and polypropylene glycol. Triols, such as glycerin, 1, 2, 6-hexanetriol, and trimethylolpropane. These water-soluble organic solvents can be used alone or two or more kinds may be used together.

As the gas component that can be introduced in the dissolving unit 200, mention is made of, for example, hydrogen, helium, oxygen, nitrogen, methane, fluorine, neon, carbon dioxide, ozone, argon, chlorine, ethane, propane, air and the like. Further, a mixed gas including some of those described above may be accepted. Furthermore, it is not necessarily required to dissolve a material in the gas state in the dissolving unit 200 and it may also be possible to fuse a liquid or solid consisting of desired components in the liquid W. As dissolving in this case, in addition to natural dissolving, dissolving by applying a pressure may be accepted and dissolving accompanied by hydration by electrolytic dissociation, ionization, and chemical reaction may be accepted.

<<Specific Example in a Case where Ozone Gas is Used>>

Here, as one specific example, a case where ozone gas is used as the gas component is explained. First, as the ozone gas generation method, mention is made of the discharge method, the electrolysis method, and the ultraviolet light method. In the following, these methods are explained in order.

### (1) Discharge Method

The discharge method includes the silent discharge method and the surface discharge method. In the silent discharge method, an alternating-current high voltage is applied between a pair of electrodes arranged in the form of parallel flat plates or in the form of coaxial cylinder while causing oxygen-contained gas to flow. Due to this, discharge takes place in the oxygen-contained gas and ozone gas is generated. It is necessary for one of or both the front surfaces of the pair of electrodes to be covered with dielectric, such as glass. The discharge takes place in the gas (air or oxygen) accompanying the alternate fluctuation of the charge between positive and negative on the dielectric front surface.

On the other hand, in the surface discharge method, the front surface of the planar electrode is covered with dielectric, such as ceramics, and a linear electrode is arranged on the front surface of the dielectric and an alternating-current high voltage is applied between the planar electrode and the linear electrode. Due to this, discharge takes place on the front surface of the dielectric and ozone gas is generated.

### (2) Electrolysis Method

A pair of electrodes sandwiching an electrolyte membrane is arranged in water and a direct-current voltage is applied between both the electrodes. Due to this, water electrolysis occurs and ozone gas is generated simultaneously with oxygen on the oxygen generation side. As the ozone generator that is practically used, there is one in which porous titanium having a platinum catalyst layer is used as the cathode, porous titanium having a lead dioxide catalyst layer is used as the anode, and perfluoro sulfonic acid cation exchange resin is as used as the electrolyte membrane or the like. According to this generator, it is possible to generate high concentration ozone whose weight percent is 20 or higher.

### (3) Ultraviolet Light Method

By utilizing the principle in which the ozone layer of the earth is generated, ozone gas is generated by irradiating the air or the like with ultraviolet light. As the ultraviolet light, normally, a mercury light is used.

In a case where ozone gas is used as the gas component, it may also be possible to further add the ozone gas generation unit that adopts the methods (1) to (3) described above to the UFB generation apparatus 1 in FIG. 1.

Next, the dissolving method of generated ozone gas is explained. As the method suitable to dissolving ozone gas in the liquid W, in addition to the pressure dissolving method shown in FIG. 3A and FIG. 3B, mention is made of the “air bubble dissolving method”, the “diaphragm dissolving method”, and the “filled layer dissolving method”. In the following, these three methods are explained in order while comparing them to one another.

### (i) Air Bubble Dissolving Method

This is a method in which ozone gas is included in the liquid W as bubbles in a mixed manner and ozone gas is dissolved while causing ozone gas to flow together with the liquid W. For example, there is a bubbling method in which ozone gas is blown into a container in which the liquid W is stored from the bottom of the container, an ejector method in which a narrow section is provided in part of a pipe through which the liquid W is caused to flow and ozone gas is blown into the narrow section, a method in which the liquid W and ozone gas are stirred by a pump, or the like. This is a comparatively compact dissolving method and also used in a water purification plant and the like.

### (ii) Diaphragm Dissolving Method

This is a method in which the liquid W is caused to flow through the porous Teflon (registered trademark) membrane and ozone gas is caused to flow outside thereof, and ozone gas is absorbed and dissolved into the liquid W.

(iii) Filled Layer Dissolving Method

This is a method in which the liquid W is caused to flow from the top of a filled layer and ozone gas is caused to flow from the bottom, and thereby, ozone gas and the liquid are caused to flow in opposite directions and ozone gas is dissolved into the liquid W within the filled layer.

In a case where the methods (i) to (iii) described above are adopted, it is sufficient to change the dissolving unit 200 of the UFB generation apparatus 1 from the configuration shown in FIG. 3A and FIG. 3B to a configuration that adopts one of the methods (i) to (iii).

In particular, for ozone gas whose purity is high, it is required to purchase it in a gas cylinder and the use thereof is limited unless a special environment is prepared from the standpoint of the strong poisonous characteristic. Because of this, it is difficult to generate the ozone micro bubble and the ozone ultra fine bubble by the conventional generation method of the micro bubble or the ultra fine bubble by introducing air (for example, the venturi method, the swirl flow method, the pressure dissolving method and the like).

On the other hand, as the method of generating ozone-dissolved water, a method is useful from the standpoint of safety and easiness, in which ozone is generated from oxygen supplied by the discharge method, the electrolysis method, or the ultraviolet light method and the ozone is dissolved into water or the like at the same time of the generation thereof.

However, in a case where the cavitation method or the like is adopted, it is possible to generate the ozone ultra fine bubble by using ozone-dissolved water, but the size of the apparatus becomes large and such a problem remains that it is not possible to increase the density of the ozone ultra fine bubble.

In contrast to this, the T-UFB generation method of the present embodiment is more excellent that other generation methods, such as the cavitation method, in that it is possible to relatively reduce the size of the apparatus and generate high concentration ozone ultra fine bubbles from ozone-dissolved water.

### <<Effects of T-UFB Generation Method>>

Next, the features and effects of the T-UFB generation method explained as above are explained in comparison to the conventional UFB generation method. For example, in the conventional air bubble generation apparatus represented by the venturi method, air bubbles of various sizes are generated in the downstream area of a decompression structure by providing the mechanical decompression structure, such as a decompression nozzle, in part of the flow passage and a liquid is caused to flow under a predetermined pressure so that the liquid passes the decompression structure.

In this case, among the generated air bubbles, the buoyant force acts on the bubbles whose size is comparatively large, such as the milli bubble and the micro bubble, and therefore, after a while, they float up to the liquid surface and become extinct. Further, the UFB on which the buoyant force does not act does not have so large gas-liquid interface energy, and therefore, it becomes extinct together with the milli bubble and the micro bubble. In addition, even by arranging the above-described decompression structure in series and causing the same liquid to flow through the decompression structure repeatedly, it is not possible to preserve the UFBs whose number corresponds to the number of times of repetition for a long time. That is, it is difficult to keep the UFB contain concentration at a predetermined value for a long time in the UFB-contained liquid generated by the conventional UFB generation method.

In contrast to this, in the T-UFB generation method of the present embodiment, which utilizes film boiling, the rapid change in temperature from the normal temperature to about 300° C. and the rapid change in pressure from the normal pressure to about several MPa are caused to take place locally in the very close vicinity of the heating element. This heating element has the shape of a rectangle whose one side is about several tens of μm to hundred μm. Compared to the conventional UFB generator, the size is about 1/10 to 1/100. Further, by the gas-contained liquid existing in the very thin film area on the front surface of the film boiling bubble instantaneously (for a very short time less than or equal to a microsecond) exceeding the thermal solubility limit or the pressure solubility limit, the phase transition takes place and the UFB precipitates. In this case, the bubbles whose size is comparatively large, such as the milli bubble and the micro bubble, is hardly generated and in the liquid, the UFB whose diameter is about 100 nm is contained with very high purity. Further, the T-UFB thus generated has sufficiently high gas-liquid interface energy, and therefore, the T-UFB is unlikely to be damaged in the normal environment and can be preserved for a long time.

In particular, in the present embodiment in which the film boiling phenomenon capable of forming the gas interface locally in the liquid, it is possible to form the interface in part of the liquid and make the area that acts in terms of heat and pressure accompanying the formation an extremely local range without affecting the entire liquid area. As a result of that, it is possible to generate the desired UFB stably. Further, by circulating the liquid and further giving the UFB generation condition to the generated liquid, it is possible to additionally generate the new UFB with less influence on the already existing UFB. As a result of that, it is possible to manufacture the UFB liquid with the desired size and concentration comparatively easily.

Further, in the T-UFB generation method, because of having the above-described hysteresis characteristic, it is possible to increase the content concentration up to the desired concentration while maintaining high purity. That is, according to the T-UFB generation method, it is possible to efficiently generate the UFB-contained liquid whose purity and concentration are high and which can be preserved for a long time.

Here, the method of dissolving ozone gas into the liquid W is explained, but the method may be a method of dissolving nitrogen monoxide in place of ozone gas. The case where nitrogen monoxide is used is suitable to the medical clinical application by utilizing the biological activity function.

### <<Manufacturing Apparatus of Ultra Fine Bubble-Contained Liquid>>

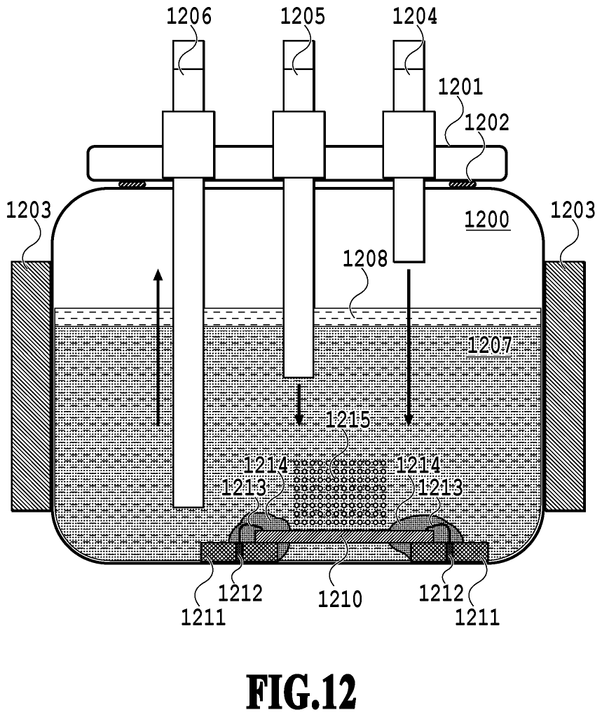

FIG. 12 shows a manufacturing apparatus of an ultra fine bubble-contained liquid in the present embodiment. To a T-UFB manufacturing container 1200, a liquid supply unit 1205 configured to supply a liquid from which contained gas, such as air, has been removed by a deaeration unit, not shown schematically, and a gas supply unit 1204 configured to supply gas from which impurities have been removed are attached. To the T-UFB manufacturing container 1200, gas that is to be dissolved in a liquid 1207 supplied from the liquid supply unit 1205 is supplied from the gas supply unit 1204. The liquid from the liquid supply unit 1205 is supplied to the inside of the T-UFB manufacturing container 1200 through a liquid supply port and a liquid introduction passage, which the T-UFB manufacturing container 1200 comprises, and stored therein. The gas from the gas supply unit 1204 is supplied to the inside of the T-UFB manufacturing container 1200 through a gas supply port and a gas introduction passage, which the T-UFB manufacturing container 1200 comprises.

Further, to the T-UFB manufacturing container 1200, a collection unit 1206 configured to collect the UFB-contained liquid generated within the T-UFB manufacturing container 1200 is also attached. The collection unit 1206 collects the ultra fine bubble-contained liquid generated within the T-UFB manufacturing container 1200 through a collection passage and a collection port (also referred to as discharge port), which the T-UFB manufacturing container 1200 comprises. Then, in order to maintain airtightness of the T-UFB manufacturing container 1200 and high pressure within the container, a hermetic lid 1201 and a sealing material 1202 are arranged. It is possible to control the internal pressure within the T-UFB manufacturing container 1200 to the atmospheric pressure or higher by adjusting the gas introduction pressure from the gas supply unit 1204 in order to increase the internal pressure. Further, in order to increase the gas solubility concentration in the liquid, a cooling unit 1203 that comes into contact with the outer circumferential side surface of the T-UFB manufacturing container 1200 is arranged. By this cooling unit, the liquid temperature within the T-UFB manufacturing container 1200 is adjusted to the temperature lower than or equal to the temperature in the room in which the container is installed (that is, lower than or equal to the environment temperature), desirably, 10° C. or lower.

Next, within the T-UFB manufacturing container 1200 shown in FIG. 12, a T-UFB generation unit 1210 configured to generate a plurality of T-UFBs 1215 is arranged. The T-UFB generation unit 1210 is arranged on a support member 1211. To the T-UFB generation unit 1210, a power source and electric signals, which are necessary, are supplied via a wire 1212 and a wire 1213 for electrical connection from an external control system, not shown schematically. The wire 1212 and the wire 1213 are sealed and protected with a sealing agent 1214 in order to prevent corrosion of the electric wire. In order to prevent the plurality of the T-UFBs 1215 having occurred from the T-UFB generation unit from becoming extinct by floating within the liquid 1207 for a long time and coming into contact with the outside air, a gas-liquid separation film 1208 is arranged on the gas-liquid interface within the T-UFB manufacturing container 1200. As the gas-liquid separation film 1208 that is used in the present embodiment, a fluorine resin is suitable. The fluorine resin has ozone resistance and base resistance and also has oxygen monoxide resistance. Specifically, mention is made of PTFE (polytetrafluoroethylene), PFA (perfluoroalkoxyalkane), and ETFE (ethylene-tetrafluoroethylene-copolymer). Further, mention is also made of FEP (perfluoroethylene-propanecopolymer), PCTFE (polychlorotrifluoroethylene), and ECTFE (ethylene-chlorotrifluoroethylencopolymer). It is desirable for the gas-liquid separation film 1208 to consist of one or more substances enumerated here.

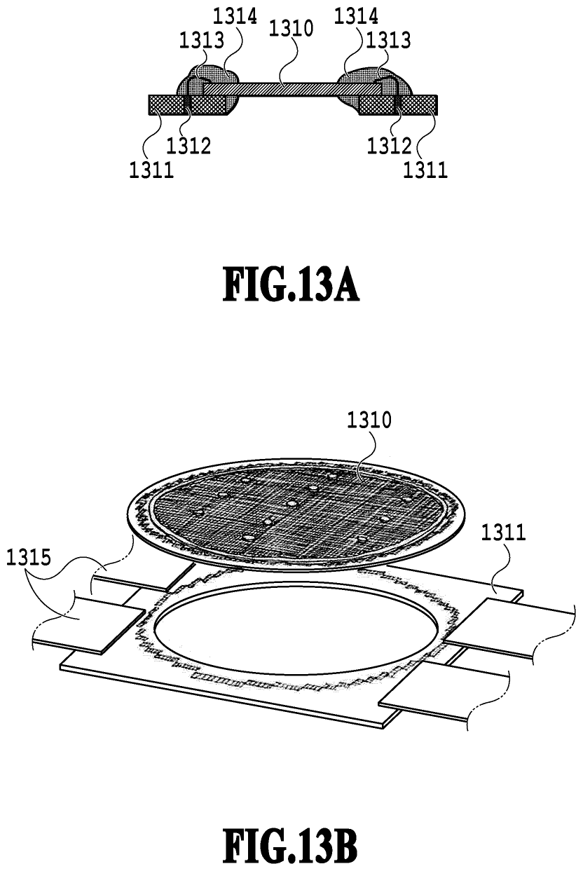

FIG. 13 and FIG. 13B show a T-UFB generation unit 1310 corresponding to the T-UFB generation unit 1210 (see FIG. 12) described previously and a configuration relating to electrical connection with an external control system, not shown schematically. The T-UFB generation unit 1310 is arranged on a support member 1311. From the external control system, not shown schematically, via a wire 1312 and a wire 1313 for electrical connection, a power source and electric signals, which are necessary, are supplied to the T-UFB generation unit 1310. The wire 1312 and the wire 1313 are sealed and protected with a sealing agent 1314 in order to prevent corrosion. Electrical connection between the support member 1311 and the external control system, not shown schematically, is made via a flexible substrate 1315 shown in FIG. 13B.

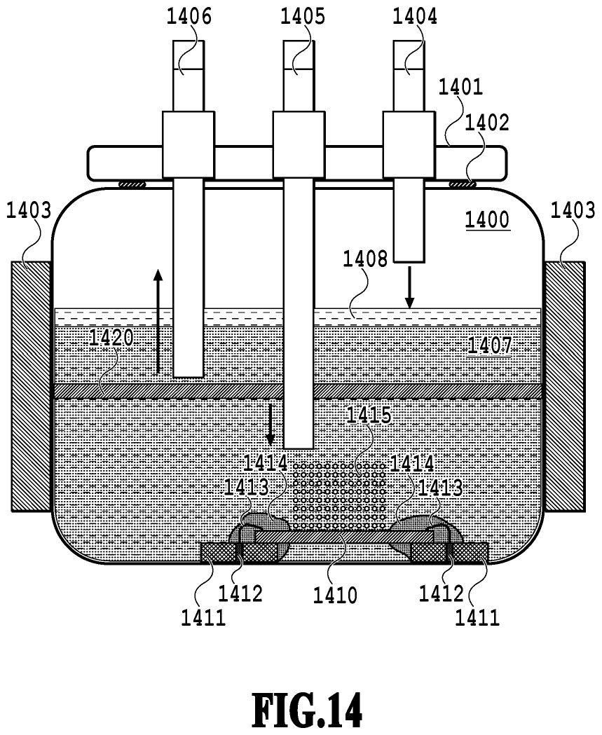

FIG. 14 shows a manufacturing apparatus of an ultra fine bubble-contained liquid in an aspect different from that in FIG. 12. To a T-UFB manufacturing container 1400, a liquid supply unit 1405 configured to supply a liquid from which contained gas, such as air, has been removed by a deaeration unit, not shown schematically, and a gas supply unit 1404 configured to supply gas from which impurities have been removed are attached. To the T-UFB manufacturing container 1400, gas to be dissolved into a liquid 1407 supplied from the liquid supply unit 1405 is supplied from the gas supply unit 1404. Further, to the T-UFB manufacturing container 1400, a collection unit 1406 configured to collect the UFB-contained liquid generated within the T-UFB manufacturing container 1400 is also attached. Then, in order to maintain airtightness of the T-UFB manufacturing container 1400 and high pressure within the container, a hermetic lid 1401 and a sealing material 1402 are arranged. It is possible to control the internal pressure within the T-UFB manufacturing container 1400 to the atmospheric pressure or higher by adjusting the gas introduction pressure from the gas supply unit 1404 in order to increase the internal pressure. Further, in order to increase the gas solubility concentration in the liquid, a cooling unit 1403 that comes into contact with the outer circumferential side surface of the T-UFB manufacturing container 1400 is arranged. By this cooling unit, the liquid temperature within the T-UFB manufacturing container 1400 is adjusted to the temperature lower than or equal to the room temperature, desirably, 10° C. or lower.

Within the T-UFB manufacturing container 1400 shown in FIG. 14, a T-UFB generation unit 1410 configured to generate a plurality of T-UFBs 1415 is arranged. The T-UFB generation unit 1410 is arranged on a support member 1411. To the T-UFB generation unit 1410, a power source and electric signals, which are necessary, are supplied via a wire 1412 and a wire 1413 for electrical connection from an external control system, not shown schematically. The wire 1412 and the wire 1413 are sealed and protected with a sealing agent 1414 in order to prevent corrosion of the electric wire. In order to prevent the plurality of the T-UFBs 1415 from becoming extinct by floating within the liquid 1407 for a long time and coming into contact with the outside air, a gas-liquid separation film 1408 is arranged within the T-UFB manufacturing container 1400. As the gas-liquid separation film 1408 that is used in the present embodiment, a fluorine resin is suitable. The fluorine resin has ozone resistance and base resistance and also has oxygen monoxide resistance. Specifically, mention is made of PTFE (polytetrafluoroethylene), PFA (perfluoroalkoxyalkane), and ETFE (ethylene-tetrafluoroethylene-copolymer). Further, mention is also made of FEP (perfluoroethylene-propanecopolymer), PCTFE (polychlorotrifluoroethylene), and ECTFE (ethylene-chlorotrifluoroethylencopolymer). It is desirable for the gas-liquid separation film 1408 to consist of one or more substances enumerated here.

Further, within the T-UFB manufacturing container 1400, a filter 1420 in which minute holes are bored is arranged in order to concentrate the generated T-UFBs 1415. This filter has a number of minute holes whose diameter is less than or equal to 1.0 μm and allows only the UFBs whose diameter is less than or equal to 1.0 μm among the plurality of the UFBs having occurred in the T-UFB generation unit 1410 to pass.

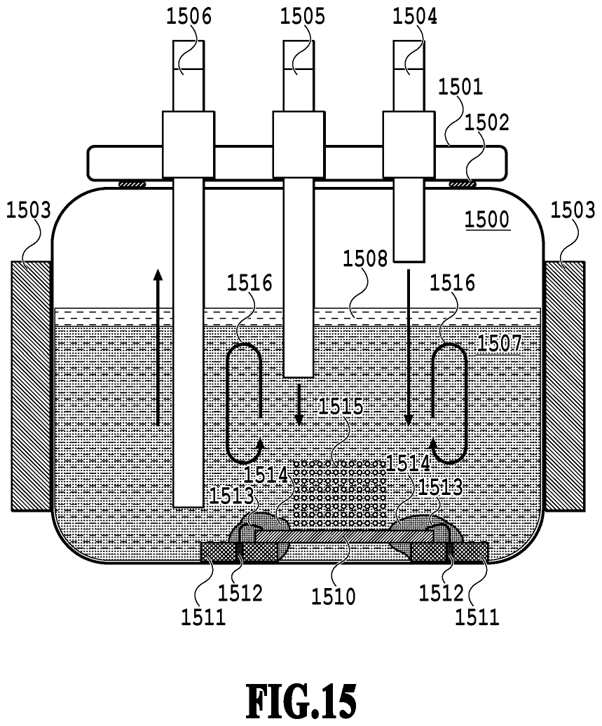

Next, by using FIG. 15, the arrangement effect of a T-UFB generation unit 1510 in the present embodiment is explained. The T-UFB generation unit 1510 utilizes the phenomenon of film boiling, and therefore, the temperature of the substrate in the T-UFB generation unit 1510 rises. Although depending on the drive frequency of the heater, there is a case where the temperature of the entire substrate rises up to about 60° C. Because of that, the temperature of gas-dissolved water 1507 in the vicinity of the T-UFB generation unit 1510 also rises. As a result of that, an upward flow as part of Marangoni convection 1516 occurs within the gas-dissolved water 1507 within a T-UFB manufacturing container 1500.

Then, by a cooling unit 1503 arranged outside the T-UFB manufacturing container 1500, the gas-dissolved water 1507 at the top is cooled and due to the effect of Marangoni convection, the cooled gas-dissolved water is supplied to the vicinity of the T-UFB generation unit 1510. Due to this, it is possible to suppress the rise in temperature of the substrate of the T-UFB generation unit 1510. Further, by the gas-dissolved water 1507 being cooled, it is possible to increase the solubility of gas supplied from a gas supply unit 1504 and as a result, it is possible to further dissolve the gas into the T-UFB-dissolved water. That is, as regards the solubility of gas in a liquid, the gas saturated solubility is determined depending on temperature and pressure, but the gas having contributed to the UFB generation by the T-UFB generation unit 1510 changes into gas that does not depend on the magnitude of solubility by being included within the UFB. As described above, according to the present embodiment, it is possible to implement a mechanism that reduces the solubility of gas in a liquid and further dissolves the gas into the liquid whose gas solubility has been reduced.

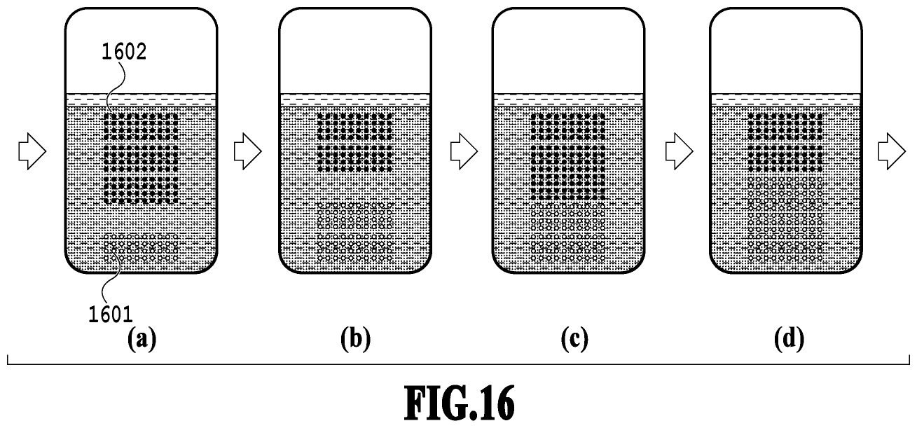

FIG. 16 shows a series of flow of ultra fine bubble-contained liquid generation by the mechanism such as this. As shown (a) in FIG. 16, by a T-UFB generation unit (not shown schematically), part of gas 1602 dissolved in gas-dissolved water is changed into a T-UFB 1601. As a result of that, as shown (b) in FIG. 16, the solubility of the gas 1602 is reduced. After that, in a case where the gas 1602 is supplied from a gas supply unit (not shown schematically), the state changes into one shown (c) in FIG. 16. Then, as shown (d) in FIG. 16, by the T-UFB generation unit (not shown schematically), part of the gas 1602 dissolved in the gas-dissolved water is changed into the T-UFB 1601. As described above, by repeating the changing from gas into the T-UFB by the T-UFB generation unit and the supply of gas from the gas supply unit, it is possible to stably generate UFB water whose concentration is high.

In a case where nitrogen monoxide is dissolved in a liquid, it is preferable to use a CFC-based material having nitrogen monoxide resistance for the pipe and the like through which nitrogen monoxide passes before being dissolved.

### First Embodiment

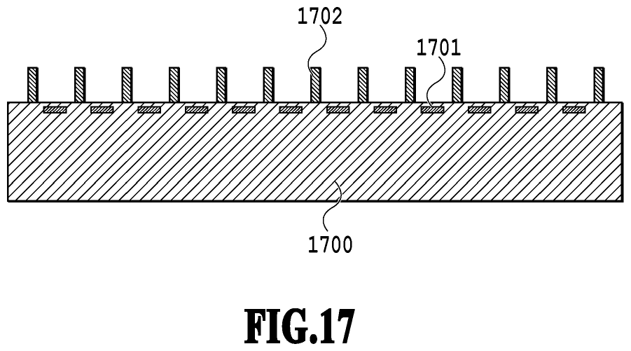

FIG. 17 is an example of an enlarged diagram of the T-UFB generation unit 1210 shown in FIG. 12. A plurality of heaters 1701 including the heating element shown in FIG. 5A is arranged on an element substrate 1700. In order to suppress interference of air bubbles that occur in the heater 1701, a barrier 1702 is provided between the adjacent heaters. Due to the barrier 1702, during the operation in which air bubbles occur and disappear in one certain heater, it is possible to suppress a phenomenon in which air bubbles that occur in the heater adjacent to the one certain heater become unlikely to grow.

It is desirable for the height of the barrier to be not less than 1.0 μm and not more than 100 μm. In view of the initial thickness in film boiling described previously, in a case where the height is not more than or equal to 1.0 μm, the effect of suppression of interference between the adjacent heaters is not obtained. On the other hand, in view of the maximum bubble diameter, in a case where the height is more than or equal to 100 μm, there is a possibility that the liquid supply capacity after bubble disappearance is suppressed. The height of the barrier is preferably 10 to 50 μm.

Further, as the material of the barrier, a film deposition material, such as silicon nitride, a photosensitive epoxy resin or the like is suitable. However, in view of ozone resistance and base resistance, inorganic silicon nitride is preferable.

Although not shown in FIG. 17, it may also be possible to provide a substrate for cooling the substrate 1700 at the bottom of the substrate 1700.

### Second Embodiment

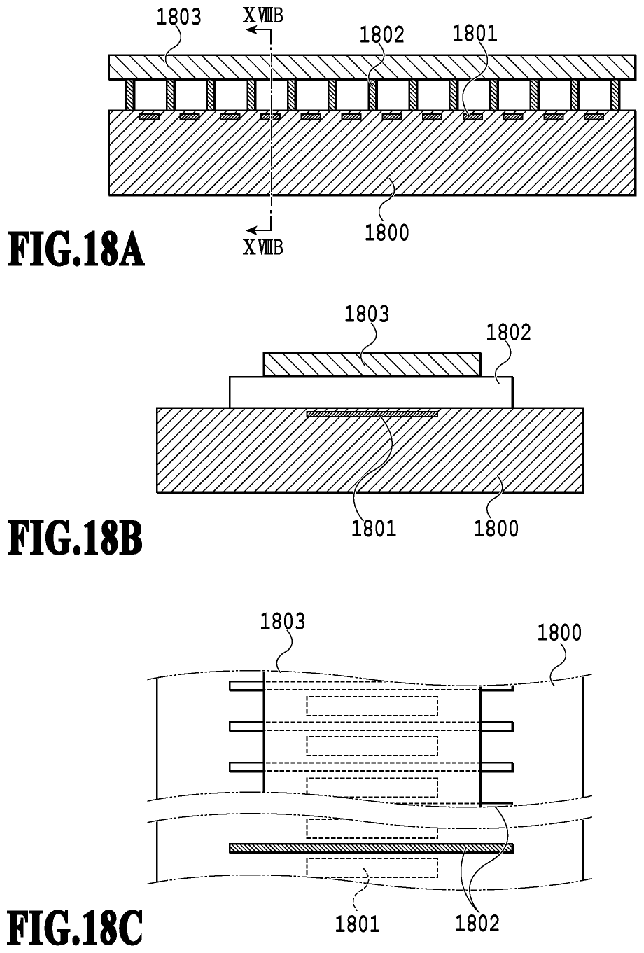

FIG. 18A is an example of an enlarged diagram of the T-UFB generation unit 1210 (see FIG. 12) in the present embodiment. In FIG. 18A, barriers 1802 between heaters are arranged at predetermined intervals in the row direction in which a plurality of heaters 1801 is arranged side by side. On the barriers 1802, a top plate 1803 is arranged. FIG. 18B is a cross-sectional diagram along a section line in FIG. 18A. As shown in FIG. 18A or FIG. 18B, the height of the top plate 1803 is less than the height of the barrier 1802. The reason is to facilitate the supply of a solution to the heater 1801. FIG. 18C is a top diagram of FIG. 18A.

### Third Embodiment

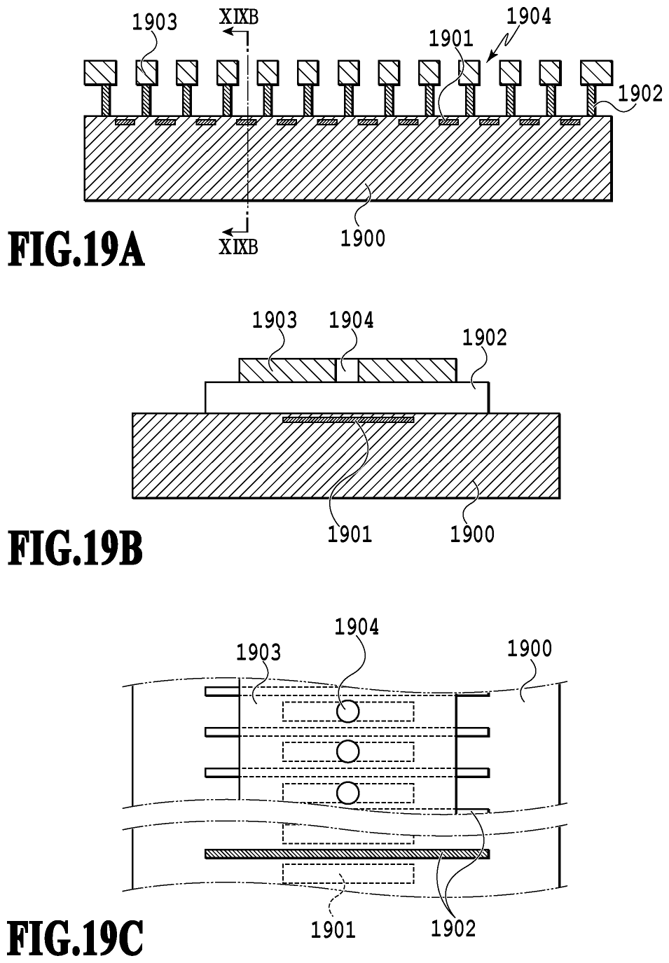

FIG. 19A to FIG. 19C are each an example of an enlarged diagram of the T-UFB generation unit 1210 (see FIG. 12) in the present embodiment. In FIG. 19A, barriers 1902 between heaters are arranged at predetermined intervals in the row direction in which a plurality of heaters 1901 is arranged side by side. On the barriers 1902, a top plate 1903 is arranged. Further, in the top plate 1903, through holes 1904 are formed in correspondence to the heaters 1901. FIG. 19B is a cross-sectional diagram along a section line in FIG. 19A. As shown in FIG. 19A or FIG. 19B, the height of the top plate 1903 is less than the height of the barrier 1902. The reason is to facilitate the supply of a solution to the heater 1901. FIG. 19C is a top diagram of FIG. 19A. By forming the through hole 1904 in the top plate 1903, it is possible to cause a flow of the solution to take place suddenly to increase the negative pressure within the solution.

According to one embodiment of the present invention, it is made possible to provide a manufacturing apparatus of an ultra fine bubble-contained liquid that can be utilized effectively because high concentration ultra fine bubbles are maintained for a long time at the time of manufacturing of the ultra fine bubble-contained liquid.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-040221, filed Mar. 12, 2021, which is hereby incorporated by reference wherein in its entirety.

What is claimed is:

1. A manufacturing apparatus of an ultra fine bubble-contained liquid, the manufacturing apparatus comprising:
a container having a gas supply port through which gas is introduced and a liquid supply port through which a liquid is introduced; and
a generation unit inside the container, which is configured to cause an ultra fine bubble to occur in the liquid in which the gas is dissolved.

2. The manufacturing apparatus according to claim 1, wherein
the container further has a discharge port through which the ultra fine bubble-contained liquid is discharged.

3. The manufacturing apparatus according to claim 1, wherein
the generation unit has a first substrate and a heater that is provided on the first substrate.

4. The manufacturing apparatus according to claim 3, wherein
by driving the heater, film boiling takes place in the liquid.

5. The manufacturing apparatus according to claim 3, further comprising:
a second substrate for cooling the first substrate at the bottom of the first substrate.

6. The manufacturing apparatus according to claim 1, wherein
pressure inside the container is controlled by adjusting introduction pressure of the gas that is introduced through the gas supply port.

7. The manufacturing apparatus according to claim 1, wherein
the pressure inside the container is higher than or equal to atmospheric pressure and
temperature inside the container is lower than or equal to environment temperature.

8. The manufacturing apparatus according to claim 1, wherein
the generation unit is arranged at the bottom of the container.

9. The manufacturing apparatus according to claim 1, further comprising:
a gas-liquid separation film located at a gas-liquid interface inside the container.

10. The manufacturing apparatus according to claim 9, wherein
the gas-liquid separation film prevents contact between the ultra fine bubble and the gas inside the container.

11. The manufacturing apparatus according to claim 9, wherein
the gas-liquid separation film consists of at least one or more of polytetrafluoroethylene, perfluoroalkoxyalkane, ethylene-tetrafluoroethylene-copolymer, perfluoroethylene-propanecopolymer, polychlorotrifluoroethylene, and ethylene-chlorotrifluoroethylencopolymer.

12. The manufacturing apparatus according to claim 9, further comprising:
a filter, wherein
the position of the filter is above the generation unit and under the gas-liquid separation film.

13. The manufacturing apparatus according to claim 12, wherein
diameters of a plurality of minute holes of the filter are 1.0 μm or less.

14. The manufacturing apparatus according to claim 1, further comprising:
a cooling unit configured to cool the liquid stored inside the container and the ultra fine bubble-contained liquid, wherein
the cooling unit is attached to a side surface of the container.
